(19) United States
(12) Patent Application Publication
(10) Pub. No.: US 2007/0116041 A1
(43) Pub. Date: May 24, 2007

(54) Digital broadcast receiver

(76) Inventor: Yasuaki Hashimoto, Kyoto (JP)

Correspondence Address: MCDERMOTT WILL & EMERY LLP, 600 13TH STREET, N.W., WASHINGTON, DC, 20005-3096, US

(21) Appl. No.: 11/545,769

(22) Filed: Oct. 11, 2006

(30) Foreign Application Priority Data
Oct. 14, 2005 (JP) 2005-300009

(51) Int. Cl. H04J 3/22

(52) U.S. Cl. 370/465; 370/412

(57) ABSTRACT

The digital broadcast receiver has a main broadcast audio input buffer for storing therein an audio stream of a main broadcast and a data broadcast audio input buffer for storing therein an audio stream of a data broadcast. The audio streams in the main broadcast audio input buffer and the data broadcast audio input buffer are selectively inputted into an audio decoder depending on the broadcast to be played back. During playback of a data broadcast, the audio stream is discarded in units of PES packets from the main broadcast audio input buffer.

### CROSS-REFERENCE TO RELATED APPLICATIONS

The entire contents of Patent Application No. 2005-300009 filed in Japan on Oct. 14, 2005, including its description, drawings and matters disclosed under the claims, are hereby incorporated by reference.

### BACKGROUND OF THE INVENTION

1. Field of the Invention

The present invention relates to a digital broadcast receiver for receiving a multiplexed signal in which at least an audio stream of a main broadcast and an audio stream of a data broadcast are multiplexed.

2. Background Art

In recent years, with the progress of the compression coding technology for moving-picture and voice signals, it has become possible to compression-code moving-picture and voice signals used in general TV broadcasting, multiplex the compression-coded signals and transmit the multiplexed signal as a digital broadcast. Also, with the digitization of broadcast waves, it has become possible to transmit various types of multimedia information as a data broadcast.

Digital broadcast receivers for receiving such digital broadcasts have limitations on the timing at which the compression-coded signals are decoded. Therefore, an image may be discontinued and thus not be presented temporarily at the time of switching of the receiving channel. This may cause the viewer to feel discomfort. For this reason, some conventional digital broadcast receivers adopt the following scheme. As for voice, an audio stream of a newly received channel is decoded with an audio decoder and outputted as an audio signal. As for an image, however, information previously extracted from an electronic program guide (EPG) is outputted as a video signal (see Japanese Laid-Open Patent Publication No. 2001-339663, for example).

In the digital broadcast receivers configured as described above, it is possible to lessen the discomfort that may be felt when an image is discontinued and thus not presented temporarily at the time of channel switching.

A digital broadcast receiver may be provided with an audio stream buffer in which audio streams of a main broadcast and a data broadcast received are temporarily stored, for the purposes of responding to a data broadcast of a data carousel scheme in which same data is transmitted repeatedly, adjusting the timing of decoding, and the like.

However, in the digital broadcast receiver having such an audio stream buffer, the following problem arises. In switching between a main broadcast and a data broadcast, it is necessary to discard the remainder of an audio stream left in the audio stream buffer before storing a new audio stream in the buffer. This may cause discontinuation of supply of the audio stream to the audio decoder and thus possibly discontinue the audio signal. In this case, also, the viewer may possibly feel discomfort.

### SUMMARY OF THE INVENTION

An object of the present invention is providing a digital broadcast receiver capable of lessening discomfort that may be felt by the viewer when the audio signal is discontinued at the time of switching between a main broadcast and a data broadcast.

To solve the above problem, the present invention is directed to a digital broadcast receiver for receiving a multiplexed signal in which at least an audio stream of a main broadcast and an audio stream of a data broadcast are multiplexed, the receiver including:

a main broadcast audio input buffer for storing therein the audio stream of the main broadcast;

a data broadcast audio input buffer for storing therein the audio stream of the data broadcast;

an audio decoder for decoding an inputted audio stream;

a selector for switching between the audio stream stored in the main broadcast audio input buffer and the audio stream stored in the data broadcast audio input buffer, to allow the selected audio stream to be inputted into the audio decoder; and

a control section for controlling the switching of the selector according to an inputted control signal.

In the digital broadcast receiver described above, preferably, the multiplexed signal includes playback time information indicating the time at which playback is performed,

wherein the control section is configured to discard the audio stream stored in the main broadcast audio input buffer in units in which playback is made according to the playback time information, during the time when the data broadcast is being played back.

With the digital broadcast receivers described above, it is possible to lessen discomfort that may be felt by the viewer when the audio signal is temporarily disconnected at the time of switching of the object to be played back between a main broadcast and a data broadcast.

Alternatively, the present invention is directed to a digital broadcast receiver for receiving a multiplexed signal in which at least an audio stream of a main broadcast and an audio stream of a data broadcast are multiplexed, the receiver including:

a main broadcast audio input buffer for storing therein the audio stream of the main broadcast;

a data broadcast audio input buffer for storing therein the audio stream of the data broadcast;

a main broadcast audio decoder for decoding the inputted audio stream of the main broadcast;

a data broadcast audio decoder for decoding the inputted audio stream of the data broadcast;

a selector for switching between an output of the main broadcast audio decoder and an output of the data broadcast audio decoder, to output the selected output; and

a control section for controlling the switching of the selector according to an inputted control signal.

In the digital broadcast receiver described above, preferably, the multiplexed signal includes playback time information indicating the time at which playback is performed,

wherein the main broadcast audio decoder is configured to discard the inputted audio stream in units in which playback is made according to the playback time information, during the time when the data broadcast is being played back.

With the digital broadcast receivers described above, it is possible to shorten the silent time period that may occur at the time of switching of the object to be played back between a main broadcast and a data broadcast.

In the digital broadcast receiver described above, the main broadcast audio decoder may be configured to discard the inputted audio stream in units of decoding during the time when the data broadcast is being played back.

With the digital broadcast receiver described above, the audio stream is discarded in units of decoding. Therefore, the load of the control section can be reduced.

### BRIEF DESCRIPTION OF THE DRAWINGS

FIG. 1 is a block diagram of a digital broadcast receiver of Embodiment 1.

FIG. 2 is a flowchart followed when switching is made from a main broadcast to a data broadcast in the digital broadcast receiver of Embodiment 1.

FIG. 3 is a timing chart followed when switching is made from a main broadcast to a data broadcast in the digital broadcast receiver of Embodiment 1.

FIG. 4 is a flowchart followed when switching is made from a data broadcast to a main broadcast in the digital broadcast receiver of Embodiment 1.

FIG. 5 is a timing chart followed when switching is made from a data broadcast to a main broadcast in the digital broadcast receiver of Embodiment 1.

FIG. 6 is a block diagram of a digital broadcast receiver of Embodiment 2.

FIG. 7 is a flowchart followed when switching is made from a main broadcast to a data broadcast in the digital broadcast receiver of Embodiment 2.

FIG. 8 is a timing chart followed when switching is made from a main broadcast to a data broadcast in the digital broadcast receiver of Embodiment 2.

FIG. 9 is a flowchart followed when switching from a data broadcast to a main broadcast in the digital broadcast receiver of Embodiment 2.

FIG. 10 is a timing chart followed when switching is made from a data broadcast to a main broadcast in the digital broadcast receiver of Embodiment 2.

### DESCRIPTION OF THE PREFERRED EMBODIMENTS

Hereinafter, as embodiments of the present invention, digital broadcast receivers for receiving a multiplexed signal transmitted thereto, in which at least images and voice of a main broadcast and voice of a data broadcast are coded and the coded ones are multiplexed based on the Moving Picture Experts Group (MPEG) 2 standard, will be described with reference to the accompanying drawings.

Note that in the following description, components having substantially the same function are denoted by the same reference numeral, and the description thereof is not repeated.

### Embodiment 1

<Configuration of Digital Broadcast Receiver of Embodiment 1>

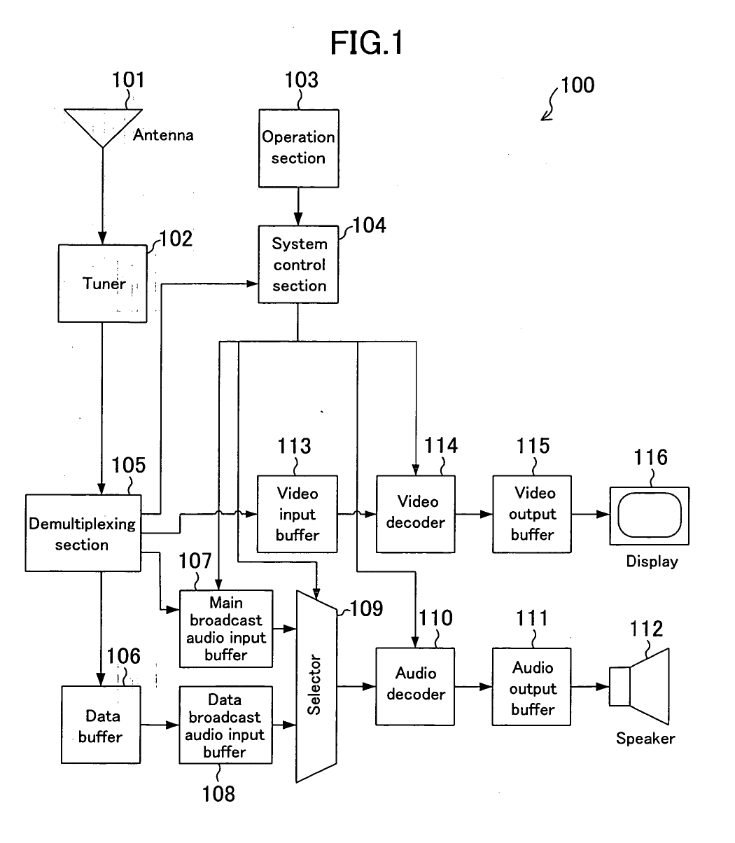

FIG. 1 is a block diagram of a digital broadcast receiver 100 of Embodiment 1 of the present invention. Referring to FIG. 1, the digital broadcast receiver 100 includes an antenna 101, a tuner 102, an operation section 103, a system control section 104, a demultiplexing section 105, a data buffer 106, a main broadcast audio input buffer 107, a data broadcast audio input buffer 108, a selector 109, an audio decoder 110, an audio output buffer 111, a speaker 112, a video input buffer 113, a video decoder 114, a video output buffer 115 and a display 116.

The antenna 101 is an antenna for receiving digital broadcasts.

The tuner 102 demodulates a digital broadcast received via the antenna 101 to a multiplexed signal as described above.

The operation section 103, which is composed of a switch and the like operated by the user, accepts an instruction from the user, such as start of playback of a data broadcast, for example, and outputs a control signal corresponding to the accepted instruction to the system control section 104.

The system control section 104 controls playback of a main broadcast and a data broadcast according to the control signal outputted from the operation section 104. To state more specifically, the system control section 104 controls switching of the selector 109 and also controls the decoding timing in the video decoder 114 and the audio decoder 110. Also, the system control section 104 discards an audio stream stored in the main broadcast audio input buffer 107 in units of packetized elementary stream (PES) packets according to the MPEG2 standard during playback of a data broadcast.

The PES packets as used herein are packets obtained by packetizing an audio stream and a video stream by a given unit of playback, and are used as units in which the playback time management is performed. In PES packets including an audio stream, one packet includes several compression-coded units (called audio frames) of voice data.

The PES packet also includes system information including time information such as a program clock reference (PCR) and a presentation time stamp (PTS). PTS is information indicating the time of the day at which playback is performed. For streams (audio and video) of a main broadcast, playback is made at timing determined in units of PES packets based on the time indicated by PTS (PTS time). For streams of a data broadcast of the data carousel scheme, in which same data is transmitted repeatedly, playback is made irrespective of the PTS time.

The demultiplexing section 105 demultiplexes the received signal into a video stream and an audio stream, as for a main broadcast, and outputs the resultant video stream and audio stream to the video input buffer 113 and the main broadcast audio input buffer 107, respectively.

The demultiplexing section 105 also outputs the system information (information including time information such as PCR and PTS) to the system control section 104.

Moreover, the demultiplexing section 105 outputs data included in a data broadcast to the data buffer 106.

The data buffer 106 is a buffer in which data of a data broadcast demultiplexed by the demultiplexing section 105 is stored. In the digital broadcast receiver 100, a plurality of channels of data broadcasts are received. The data buffer 106 stores therein data of such data broadcast channels.

The main broadcast audio input buffer 107 stores therein the audio stream of the main broadcast demultiplexed by the demultiplexing section 105.

The data broadcast audio input buffer 108 stores therein an audio stream of a data broadcast selected according to the control from the system control section 104 (for example, a data broadcast channel selected by the user via the operation section 103) among the data of the plurality of channels stored in the data buffer 106.

The selector 109 switches between the audio stream stored in the main broadcast audio input buffer 107 and the audio stream stored in the data broadcast audio input buffer 108, to allow the selected one to be inputted into the audio decoder 110, according to the control from the system control section 104.

The audio decoder 110 decodes the inputted audio stream according to the control from the system control section 104, and outputs the decoded one as an audio signal. The decoding by the audio decoder 110 is made in units of audio frames.

The audio output buffer 111 stores therein the audio signal outputted from the audio decoder 110.

The speaker 112 plays back the audio signal stored in the audio output buffer 111.

The video input buffer 113 stores therein the video stream of the main broadcast demultiplexed by the demultiplexing section 105.

The video decoder 114 decodes the inputted video stream according to the control from the system control section 104, and outputs the decoded one to the video output buffer 115 as a video signal.

The video output buffer 115 stores therein the video signal outputted from the video decoder 114.

The display 116 displays the video signal stored in the video output buffer 115 as an image.

(Operation of Digital Broadcast Receiver 100)

Assuming that a main broadcast is first played back after the power is turned on, for example, the digital broadcast receiver 100 operates as follows.

First, a digital broadcast received via the antenna 101 is demodulated into a multiplexed signal by the tuner 102, and then inputted into the demultiplexing section 105. The demultiplexing section 105 demultiplexes the multiplexed signal into a video stream and an audio stream which are then respectively outputted to the video input buffer 113 and the main broadcast audio input buffer 107. The demultiplexing section 105 also outputs system information including time information (such as PCR and PTS) to the system control section 104, and outputs data included in a data broadcast to the data buffer 106. The video stream stored in the video input buffer 113 is decoded by the video decoder 114 and outputted to the display 116 via the video output buffer 115 as the video signal.

The system control section 104 switches the selector 109 to allow the audio stream stored in the main broadcast audio input buffer 107 to be inputted into the audio decoder 110. This permits the audio stream of the main broadcast to be decoded by the audio decoder 110 and outputted to the speaker 112 via the audio output buffer 111 as the audio signal.

(Switching from Main Broadcast to Data Broadcast)

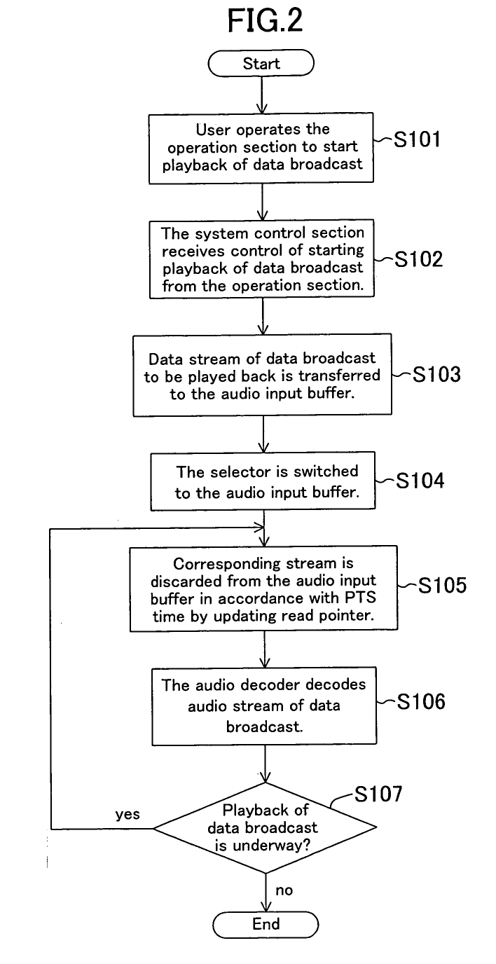

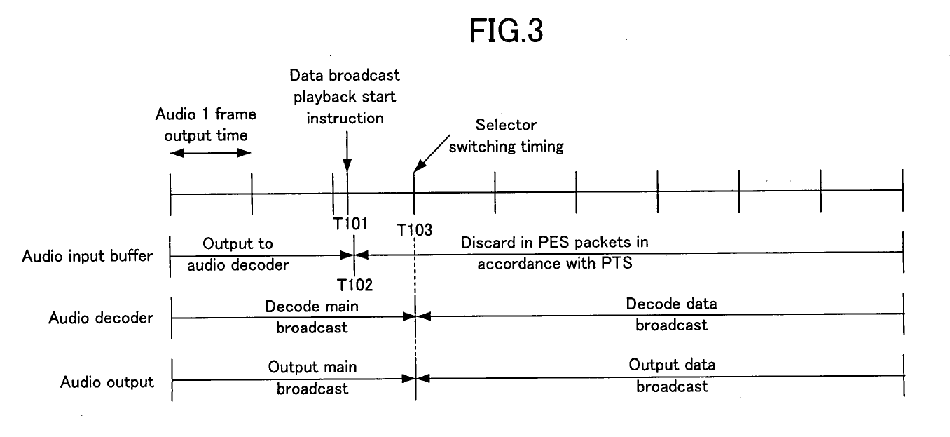

Next, the operation to be performed when the state in which a main broadcast is being played back as in the case described above is switched to the state in which a data broadcast is played back will be described with reference to the flowchart (steps S101 to S107) of FIG. 2 and the timing chart of FIG. 3.

The above switching is started with the user operating the operation section 103, for example (see S101 in FIG. 2). For example, if the operation section 103 receives an instruction of starting playback of a data broadcast from the user at timing T101 shown in FIG. 3, the system control section 104 starts transfer of an audio stream of the data broadcast from the data buffer 106 to the data broadcast audio input buffer 108 (S102 and S103). The system control section 104 then controls the switching of the selector 109 so that the audio stream stored in the data broadcast audio input buffer 108 is inputted into the audio decoder 110 at timing T103 (S104). Since it is unnecessary to start decoding of the audio stream of the data broadcast in accordance with the PTS time, the audio decoder 110 immediately starts decoding of the inputted audio stream and outputs the results (S106). In this way, the audio stream of the data broadcast is outputted to the speaker 112 via the audio output buffer 111 as the audio signal.

The transmitted audio stream of the main broadcast is provided with a PTS value for each PES packet. Therefore, the system control section 104 discards an audio stream of the main broadcast stored in the main broadcast audio input buffer 107 in accordance with the PTS time in units of PES packets, by means of advancing the read pointer in the main broadcast audio input buffer 107 or other means, during playback of the data broadcast (S105). In the example shown in FIG. 3, discarding of the audio stream is started at timing T102. The processing in S105 and S106 is repeated during playback of the data broadcast (S107).

As described above, in this embodiment, at the time of switching from a main broadcast to a data broadcast, an audio stream of the data broadcast can be decoded immediately after the switching of the selector 109 to permit input of the audio stream of the data broadcast into the audio decoder 110, and outputted as the audio signal.

(Switching from Data Broadcast to Main Broadcast)

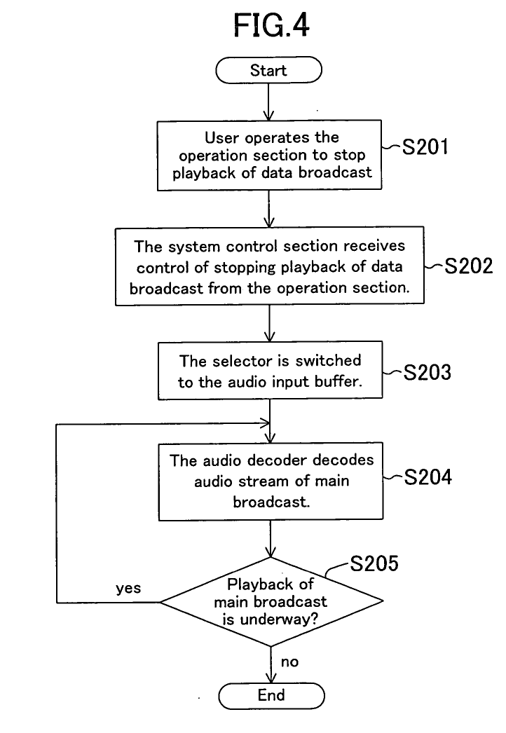

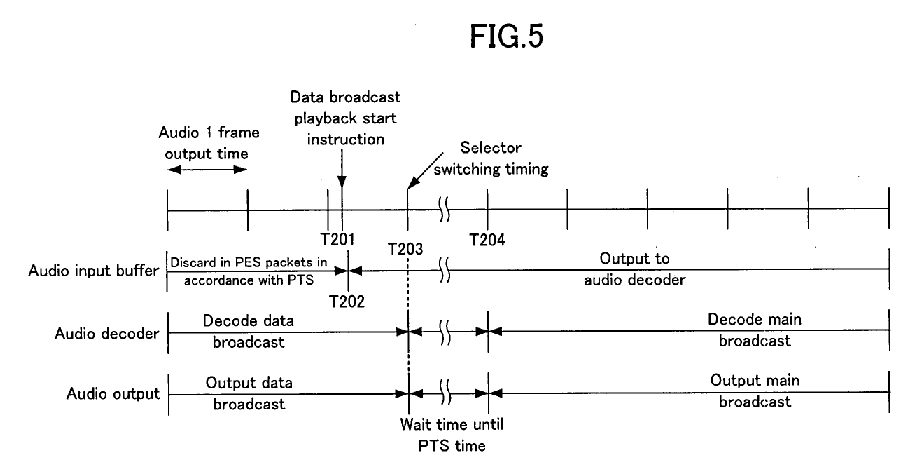

Next, the operation to be performed when the state in which a data broadcast is being played back as described above is switched to the state in which a main broadcast is played back will be described with reference to the flowchart (steps S201 to S205) of FIG. 4 and the timing chart of FIG. 5.

For example, if the operation section 103 receives an instruction of stopping playback of a data broadcast from the user at timing T201 shown in FIG. 5, the system control section 104 controls switching of the selector 109 so that an audio stream stored in the main broadcast audio input buffer 107 is inputted into the audio decoder 110 at timing T203 (S202 and S203 in FIG. 4).

The system control section 104 determines the decoding start time using the PTS time received from the demultiplexing section 105 and controls the audio decoder 110 to start decoding at and after the determined time (T204 in FIG. 5) (S204 and S205). The audio stream stored in the main broadcast audio input buffer 107 (audio stream of the main broadcast) has been discarded in units of PES packets in accordance with the PTS time. Therefore, the PTS time of the audio stream of the main broadcast read from the main broadcast audio input buffer 107 at the timing of switching from the data broadcast to the main broadcast roughly matches with the decoding start time. More specifically, considering the fact that one PES packet includes several audio frames, the time lag in this case will be the time of output of several frames. A time lag of this length will not be long enough for the viewer to feel discomfort.

As described above, in this embodiment, it is possible to lessen discomfort that may be felt by the viewer due to disconnection of the audio signal at the time of switching between a main broadcast and a data broadcast.

### Embodiment 2

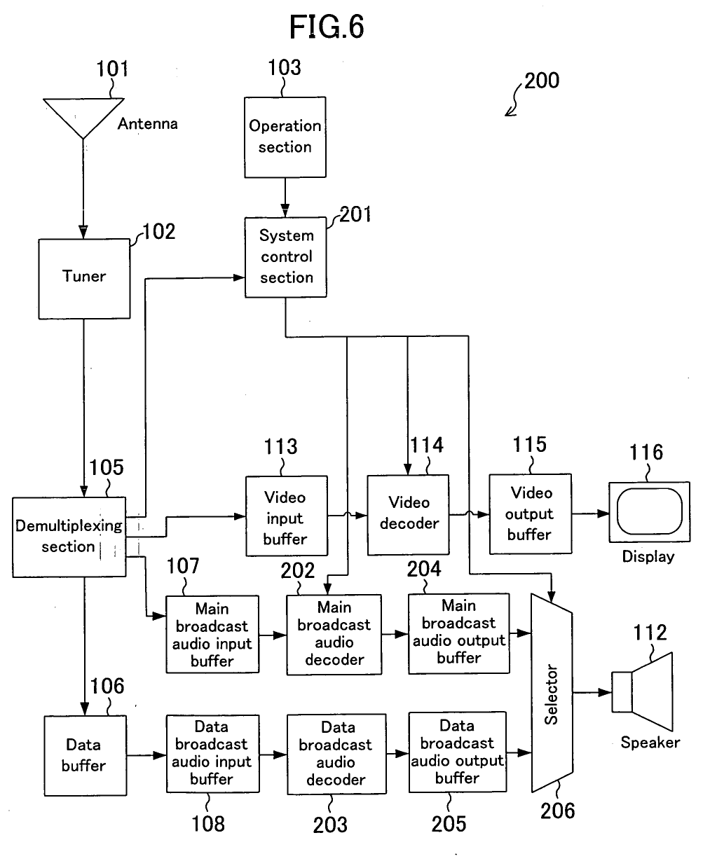

FIG. 6 is a block diagram of a digital broadcast receiver 200 of Embodiment 2 of the present invention. The digital broadcast receiver 200 includes the antenna 101, the tuner 102, the operation section 103, the demultiplexing section 105, the data buffer 106, the main broadcast audio input buffer 107, the data broadcast audio input buffer 108, the speaker 112, the video input buffer 113, the video decoder 114, the video output buffer 115, the display 116, a system control section 201, a main broadcast audio decoder 202, a data broadcast audio decoder 203, a main broadcast audio output buffer 204, a data broadcast audio output buffer 205 and a selector 206.

The system control section 201 controls playback of a main broadcast and a data broadcast according to the control signal outputted from the operation section 103 as will be described later.

The main broadcast audio decoder 202 decodes or discards an audio stream of a main broadcast inputted from the main broadcast audio input buffer 107 according to the control from the system control section 201.

To state more specifically, if receiving a control signal indicating that playback of the main broadcast is underway from the system control section 201, the main broadcast audio decoder 202 decodes the audio stream inputted via the main broadcast audio input buffer 107 in units of audio frames and outputs the results as the audio signal. If receiving a control signal indicating that playback of a data broadcast is underway, the main broadcast audio decoder 202 discards the audio stream inputted via the main broadcast audio input buffer 107 in units of audio frames (i.e., units in which decoding is performed).

The data broadcast audio decoder 203 decodes an audio stream of a data broadcast stored in the data broadcast audio input buffer 108 in units of audio frames and outputs the results as the audio signal.

The main broadcast audio output buffer 204 temporarily stores the output of the main broadcast audio decoder 202.

The data broadcast audio output buffer 205 temporarily stores the output of the data broadcast audio decoder 203.

The selector 206 switches between the audio signal stored in the main broadcast audio output buffer 204 and the audio signal stored in the data broadcast audio output buffer 205, to allow the select one to be outputted to the speaker 112, according to the control from the system control section 201.

(Operation of Digital Broadcast Receiver 200)

Assuming that a main broadcast is first played back after the power is turned on, for example, the digital broadcast receiver 200 operates as follows.

First, a digital broadcast received via the antenna 101 is demodulated into a multiplexed signal by the tuner 102, and then inputted into the demultiplexing section 105. The demultiplexing section 105 demultiplexes the multiplexed signal into a video stream and an audio stream, which are then outputted to the video input buffer 113 and the main broadcast audio input buffer 107. The demultiplexing section 105 also outputs system information including the time information (such as PCR and PTS) to the system control section 201, and outputs data included in a data broadcast to the data buffer 106.

The video stream stored in the video input buffer 113 is decoded by the video decoder 114 and outputted to the display 116 via the video output buffer 115 as the video signal.

The main broadcast audio decoder 202 decodes the audio stream stored in the main broadcast audio input buffer 107 (audio stream of the main broadcast) and stores the results in the main broadcast audio output buffer 204 as the audio signal. The audio signal stored in the main broadcast audio output buffer 204 is outputted to the speaker 112 via the selector 206 controlled by the system control section 201.

(Switching from Main Broadcast to Data Broadcast)

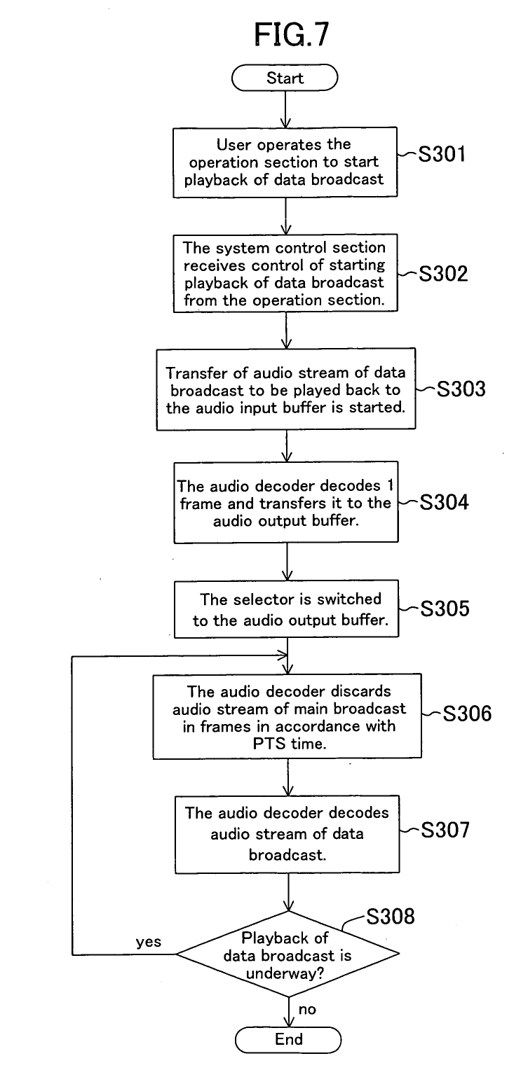

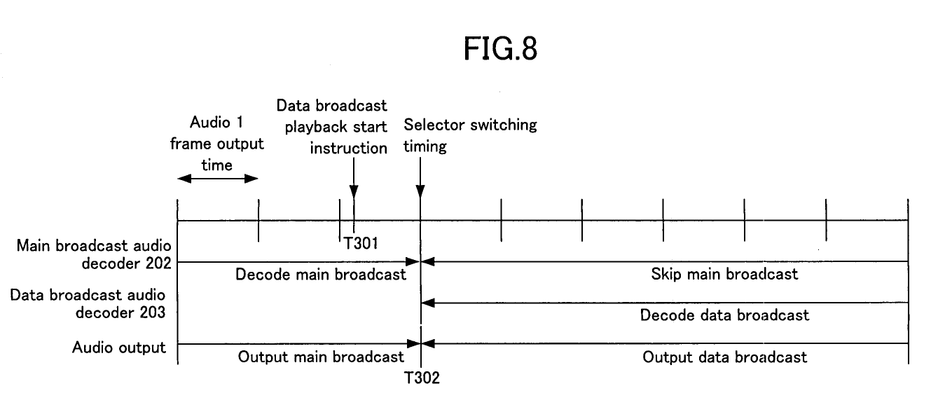

The operation performed when the state in which a main broadcast is being played back as described above is switched to the state in which a data broadcast is played back will be described with reference to the flowchart (steps S301 to S308) of FIG. 7 and the timing chart of FIG. 8.

The above switching is started with the user operating the operation section 103, for example (S301). For example, when the operation section 103 receives an instruction of starting playback of a data broadcast from the user at timing T301 shown in FIG. 8, the system control section 201 starts transfer of an audio stream of the data broadcast from the data buffer 106 to the data broadcast audio input buffer 108 (S302 and S303). After the data transfer to the data broadcast audio input buffer 108 (for example, at timing T302 in FIG. 8), the data broadcast audio decoder 203 decodes one audio frame of the audio stream stored in the data broadcast audio input buffer 108 and outputs the results to the data broadcast audio output buffer 205 (S304). In this case, also, since it is unnecessary to perform the decoding in accordance with the PTS time, the decoding can be started immediately after the input of the audio stream. Simultaneously, the system control section 201 switches the selector 206 to allow the audio signal stored in the data broadcast audio output buffer 205 to be outputted to the speaker 112 (S305). In this way, the audio signal of the data broadcast is outputted to the speaker 112 in succession to the audio signal of the main broadcast.

The system control section 201 also controls the main broadcast audio decoder 202 to discard the currently-transmitted audio stream of the main broadcast in frame units in accordance with the PTS time (S306). The decoding of the remainder of the audio stream of the data broadcast and the discarding of the unnecessary audio stream of the main broadcast are repeated until an instruction of stopping playback of the data broadcast is issued (S306 to S308).

(Switching from Data Broadcast to Main Broadcast)

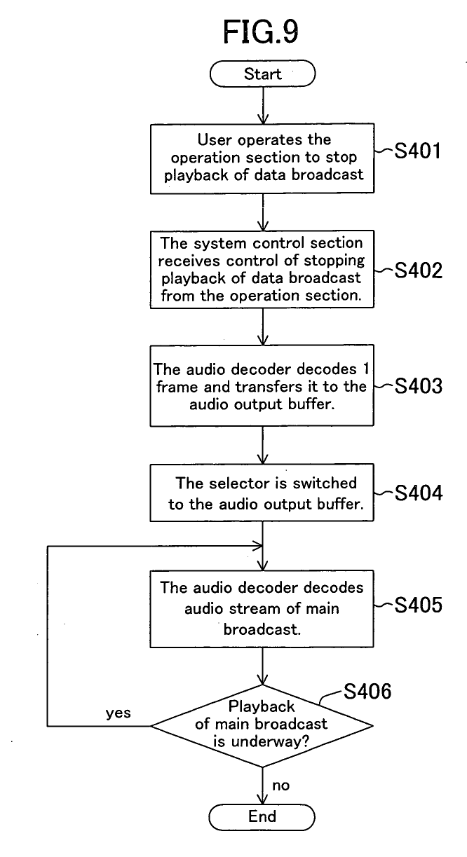

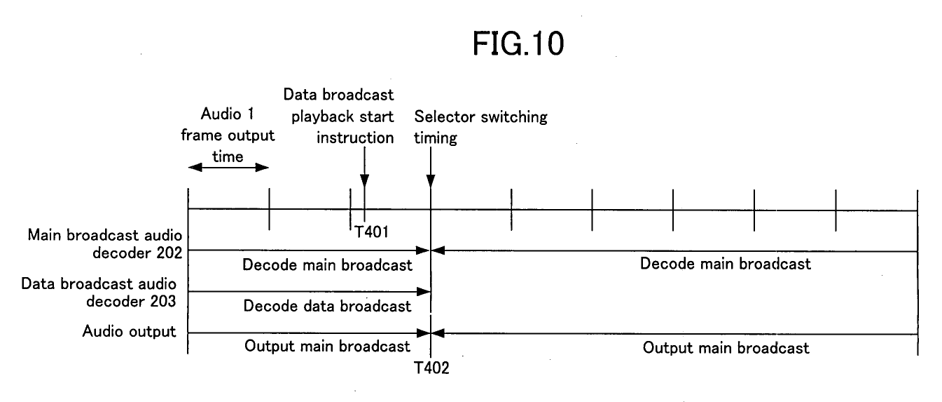

The operation performed when the state in which a data broadcast is being played back as described above is switched to the state in which a main broadcast is played back will be described with reference to the flowchart (steps S401 to S406) of FIG. 9 and the timing chart of FIG. 10.

The above switching is also started with the user operating the operation section 103, for example (S401). For example, when the operation section 103 receives an instruction of stopping playback of the data broadcast from the user at timing T401 shown in FIG. 10 (S402), the system control section 201 controls the main broadcast audio decoder 202 to decode one audio frame of the audio stream of the main broadcast and output the resultant audio signal to the main broadcast audio output buffer 204 (S403). Also, the system control section 201 switches the selector 206 to allow the audio signal stored in the main broadcast audio output buffer 204 to be outputted to the speaker 112 at timing T402 (S404). In this way, the audio signal of the main broadcast is inputted into the speaker 112 in succession to the audio signal of the data broadcast.

Decoding of the remainder of the audio stream of the main broadcast is repeated until an instruction of switching to the data broadcast is issued (S405 to S406).

As described above, in this embodiment, the main broadcast stream is discarded in accordance with the PTS time during playback of the data broadcast. Therefore, the PTS time of the audio stream of the main broadcast outputted from the main broadcast audio input buffer 107 at the timing of switching from the data broadcast to the main broadcast roughly matches with the decoding start time. In other words, it is unnecessary to provide a wait time until the decoding start time for the main broadcast.

Moreover, in this embodiment, compared with the digital broadcast receiver 100 of Embodiment 1, the switching from a data broadcast to a main broadcast can be made at higher speed because it is unnecessary to wait until a predetermined PTS time. Thus, the digital broadcast receiver 200 is suitable for applications requiring specifications strict in switching time requirements and the like. Incidentally, the digital broadcast receiver 100 of Embodiment 1 is small in the scale of the buffer for audio output, compared with the digital broadcast receiver 200. Thus, the digital broadcast receiver 100 is suitable for applications such as PDAs in which smaller hardware resources are desired.

In the digital broadcast receiver 200, the data broadcast audio decoder 203 and the main broadcast audio decoder 202 may be integrated. In this case, the audio stream of the main broadcast may be discarded in a processing time left behind after the decoding of the audio stream of the data broadcast.

In the digital broadcast receiver 200, it is not necessarily required to discard the audio stream in accordance with the PTS time. In the case of discarding the audio stream in accordance with the PTS time, the system control section 201 must be involved in the discarding because it is the system control section 201 that can read the PTS time. On the contrary, in the case of discarding the audio stream in units of decoding, the discarding can be made only with the main broadcast audio decoder 202 as long as it is made clear that playback of a data broadcast is underway. That is, the load of the system control section 201 can be reduced.

In the digital broadcast receiver 100 and the digital broadcast receiver 200, the data broadcast audio input buffer 108 may be omitted, and an audio stream may be supplied to the audio decoder directly from the data buffer 106.

As described above, the digital broadcast receiver of the present invention has an effect of lessening discomfort that may be felt by the viewer when the audio signal is temporarily disconnected at the time of switching between a main broadcast and a data broadcast, and is useful as a digital broadcast receiver that receives a multiplexed signal in which at least an audio stream of a main broadcast and an audio stream of a data broadcast are multiplexed, for example.

What is claimed is:

1. A digital broadcast receiver for receiving a multiplexed signal in which at least an audio stream of a main broadcast and an audio stream of a data broadcast are multiplexed, the receiver comprising:
a main broadcast audio input buffer for storing therein the audio stream of the main broadcast;
a data broadcast audio input buffer for storing therein the audio stream of the data broadcast;
an audio decoder for decoding an inputted audio stream;
a selector for switching between the audio stream stored in the main broadcast audio input buffer and the audio stream stored in the data broadcast audio input buffer, to allow the selected audio stream to be inputted into the audio decoder; and
a control section for controlling the switching of the selector according to an inputted control signal.

2. The digital broadcast receiver of claim 1, wherein the multiplexed signal includes playback time information indicating the time at which playback is performed,
wherein the control section is configured to discard the audio stream stored in the main broadcast audio input buffer in units in which playback is made according to the playback time information, during the time when the data broadcast is being played back.

3. A digital broadcast receiver for receiving a multiplexed signal in which at least an audio stream of a main broadcast and an audio stream of a data broadcast are multiplexed, the receiver comprising:
a main broadcast audio input buffer for storing therein the audio stream of the main broadcast;
a data broadcast audio input buffer for storing therein the audio stream of the data broadcast;
a main broadcast audio decoder for decoding the inputted audio stream of the main broadcast;
a data broadcast audio decoder for decoding the inputted audio stream of the data broadcast;
a selector for switching between an output of the main broadcast audio decoder and an output of the data broadcast audio decoder, to output the selected output; and
a control section for controlling the switching of the selector according to an inputted control signal.

4. The digital broadcast receiver of claim 3, wherein the multiplexed signal includes playback time information indicating the time at which playback is performed,
wherein the main broadcast audio decoder is configured to discard the inputted audio stream in units in which playback is made according to the playback time information, during the time when the data broadcast is being played back.

5. The digital broadcast receiver of claim 3, wherein the main broadcast audio decoder is configured to discard the inputted audio stream in units of decoding during the time when the data broadcast is being played back.
